(19) United States
(12) Patent Application Publication
(10) Pub. No.: US 2024/0051390 A1
(43) Pub. Date: Feb. 15, 2024

(54) Detecting sobriety and fatigue impairment of the rider using face and voice recognition

(71) Applicant: Reby Inc., Walnut, CA (US)

(72) Inventors: Akash Kadechkar, Barcelona (ES); Elisabet Bayo Puxan, Barcelona (ES); Julio Gonzalez Lopez, Igualada (ES); Xiaolei Song, Barcelona (ES); Ricard Comas Xanco, Tordera (ES); Eugeni Llagostera Saltor, Barcelona (ES)

(21) Appl. No.: 17/819,314

(22) Filed: Aug. 12, 2022

(51) Int. Cl. B60K 28/06; G06V 40/16; G10L 25/66

(52) U.S. Cl. CPC B60K 28/06; G06V 40/16; G10L 25/66

(57) ABSTRACT

A system and method for detecting rider impairment based on image or audio input is implemented in a rental fleet of lightweight vehicles. The system comprises a mobile device, a backend server, and one or more lightweight vehicles. Access to fleet vehicles is controlled by the mobile application based on results of data collected about the prospective driver.

### FIELD OF THE INVENTION

The present disclosure generally relates to vehicle safety systems for rental fleets of small vehicles, such as electric scooters.

### BACKGROUND OF THE INVENTION

Accidents due to impaired drivers are a known public health and safety issue. Such accidents are especially dangerous for two and three wheeled vehicles because the vehicles themselves are relatively lightweight and do offer as much protection to the driver in case of accidents. Many solutions and strict laws have been implemented to prevent vehicle accidents, but the number of accidents caused by intoxicated drivers is still a significant problem.

Moreover, with the increasing popularity of shared mobility and delivery services, the incidents of impaired driving accidents involving shared vehicles is expected to increase. Impaired drivers generally comprise drivers under the influence of alcohol and drugs and impairment due to fatigue, drowsiness, etc.

Vehicle rental services and fleet operators have frequent accidents because the driver is not necessarily familiar with the rented vehicle as with a personally owned vehicle. Besides damage to the rider and the vehicle, such accidents also result in the loss of fleet productivity, revenue, insurance claims, quality of service, up time, and so on.

There exist mobile applications for image-based detection of sobriety. There are also systems that rely on integrated vehicle cameras to collect images of a driver in a vehicle to detect driver conditions. These systems are intended for vehicles, such as cars, with sufficient space for appropriate cameras and sensors. These systems are unsuitable for lightweight vehicles because such vehicles lack an enclosure for the driver and have limited space for vehicle-mounted, driver-facing sensors.

To address these issues, there is a need for a reliable system that can prevent impaired users from driving lightweight fleet-managed vehicles and thereby avoid creating safety risks for other drivers and themselves.

### SUMMARY OF THE INVENTION

A system and method for detecting rider impairment based on image or audio input is implemented in a rental fleet of lightweight vehicles. The system comprises a mobile device, a backend server, and one or more lightweight vehicles. A prospective rider (user) of the lightweight vehicle provides biometric information by way of a mobile device. The mobile device calculates likelihood of impairment with a machine-learning algorithm. If the results of the machine-learning algorithm indicate a high probability of impairment, access to the lightweight vehicle is restricted.

In an embodiment, a system controls access to a lightweight vehicle in a shared-vehicle fleet comprising a lightweight vehicle and a mobile device communicatively coupled to an image-capture device. A central server is in communication with the mobile device and a machine-learning database comprising images indicative of impairment. The machine-learning model is trained to compare test images of human faces to human faces of subjects known to be impaired. A user face image is collected from a potential driver of the lightweight vehicle by way of the mobile device. An access-restriction mechanism for the lightweight vehicle is also provided and configured to be activated when the machine learning model determines that the user face image shows a probability of impairment exceeding a predetermined threshold.

In an alternative embodiment, the machine learning model accesses a database of voice samples not collected from the potential driver. In another embodiment, the machine learning model accesses a database of images of previously collected images that include the potential driver. Optionally, the system further comprises first and second machine-learning databases. The first database comprises third-party face images and the second database comprises images collected from user face images. The machine-learning model calculates the probability of impairment separately for each machine-learning model.

In a further embodiment, the system includes first and second machine-learning databases where the first database comprises third-party audio clips and where the second database comprises audio clips collected from users. The machine-learning model calculates the probability of impairment separately for each machine-learning model.

In an alternative embodiment, the system includes first and second machine-learning databases and the first database comprises third-party audiovisual clips while the second database comprises audiovisual clips collected from users. The machine-learning model calculates the probability of impairment separately for each machine-learning model.

In an embodiment, the system for controlling access to a lightweight vehicle in a shared-vehicle fleet comprises a lightweight vehicle and a mobile device communicatively coupled to an audio recording device. A central server is in communication with the mobile device. The system further includes a machine-learning database of audio samples indicative of impairment and a machine-learning model trained to compare test audio samples to human voice samples of subjects known to be impaired. A user voice sample is collected from a potential driver of the lightweight vehicle by way of a mobile device. An access-restriction mechanism for the lightweight vehicle is configured to be activated when the machine learning model determines that the user voice sample shows a probability of impairment exceeding a predetermined threshold.

In an embodiment, the machine learning model accesses a database of voice samples not collected from the potential driver. In a further embodiment, the machine learning model accesses a database of previously collected voice samples that include the potential driver. Alternatively, the system further comprises first and second machine-learning databases. The first database comprises third-party face images while the second database comprises images collected from user face images. The machine-learning model calculates the probability of impairment separately for each machine-learning model. In an embodiment, the system includes first and second machine-learning databases where the first database comprises third-party audio clips while the second database comprises audio clips collected from users. The machine-learning model calculates the probability of impairment separately for each machine-learning model. In a further embodiment, first and second machine-learning databases are provided, where the first database comprises third-party audio clips and the second database comprises audio clips collected from users. In this embodiment, the machine-learning model also calculates probability of impairment separately for each machine-learning model.

A method is also disclosed for controlling access to a lightweight vehicle within a shared-vehicle fleet. Audio or visual records are collected from a potential driver of the vehicle by way of a mobile device.—The machine learning model calculates a probability that the collected user record shows signs of impairment. Access to the lightweight vehicle is restricted by way of a locking mechanism when the probability of impairment exceeds a predetermined threshold.

In an embodiment, the audio or visual record comprises an image of the potential driver's face. Alternatively, the audio or visual record comprises an audio sample of the potential driver's voice. In some embodiments, the machine learning model accesses a database of images not collected from the potential driver. In other embodiments, the machine learning model accesses a database of images of previously collected images that include the potential driver. In some embodiments, the machine learning model accesses a database of voice samples not collected from the potential driver while in other embodiments the machine learning model accesses a database of previously collected voice samples that include the potential driver. In yet another embodiment, the machine learning model does not access any previously collected audio or visual record from the potential driver.

### DESCRIPTION OF THE DRAWINGS

FIG. 1A shows an embodiment where the lightweight vehicle is controlled by a backend server.

FIG. 1B shows an embodiment where the lightweight vehicle is controlled by a mobile device.

FIG. 2 shows a machine-learning algorithm for reaching a conclusion about the condition of a driver of a lightweight vehicle based on audiovisual inputs.

FIG. 3 shows an embodiment of the interaction between a backend cloud server and the mobile device used to collect user audiovisual data.

### DETAILED DESCRIPTION

The disclosed system comprises a mobile device, a backend cloud server, and shared lightweight vehicles under fleet-management control. The lightweight vehicle is typically a two-wheeled scooter, either powered or unpowered. The vehicle is ridden by its driver, who is typically the only passenger. Other lightweight vehicle configurations are also possible, with one, three, or four wheels, for example.

Enhanced safety is provided by way of a mobile device running a rider application managed by a shared mobility and fleet management entity. In a typical embodiment, a prospective lightweight vehicle driver becomes a registered fleet user by a process comprising recording a short audiovisual clip with the front camera of the mobile device before accessing a lightweight vehicle for the first time. In an embodiment, the audiovisual clip is between 5-10 seconds. The audiovisual clip captures the face and voice of the user. Alternatively, only a visual image or only audio sample is collected.

Collected data is processed using a lightweight deep learning system. Examples of currently available solutions that could be incorporated into such a system include TensorFlow or TensorFlow-Lite. The collected audio or video is processed by a mobile device application using a machine learning model trained for the detection of driver impairment. Examples of impairment include visual or audio signs of intoxication, fatigue, or unusual emotional condition.

The audiovisual sample is also sent to the backend server for tracking sample progression and fine tuning the machine-learning model. In a typical embodiment, a user identified as impaired will not be allowed to ride the vehicle and the backend server will save the audiovisual sample. In some embodiments, the audiovisual sample is marked as an impaired sample for future use in training the machine learning model. In an embodiment, the mobile device application gives the user a notification with the results of the machine learning algorithm. In some embodiments, the vehicle notifies the user through a display indication or sound, or both. The type of notification may also depend on local laws and regulations.

The system includes a cloud-computing component. A machine learning model is trained to detect impairment using face and voice recognition. A second component comprises an edge computing deployment of the model in the smartphone app for real-time detection.

In the first part, a machine learning model is created. In an embodiment, videos of intoxicated and fatigued people are collected, for example, from online sources. These videos are identified using search queries like “drunk,” “high,” “tired”, “intoxicated,” “fatigued,” “drowsy,” and so on. Collected videos are divided into two groups. The first group is used for training the model and the second group is used for testing the model. The resulting model is transformed in a lightweight structure for deployment in the mobile device application.

In the second part, the user records the video and in real-time the mobile device application processes the video and outputs the result to the user. The video and the output are also sent to the cloud for fine tuning of the AI model and controlling the vehicle. In an alternative embodiment, the backend server sends the mobile device an authentication code that allows the mobile device to unlock the lightweight vehicle directly, for example, by using a Bluetooth connection or by presenting a QR code to a scanner on the lightweight vehicle.

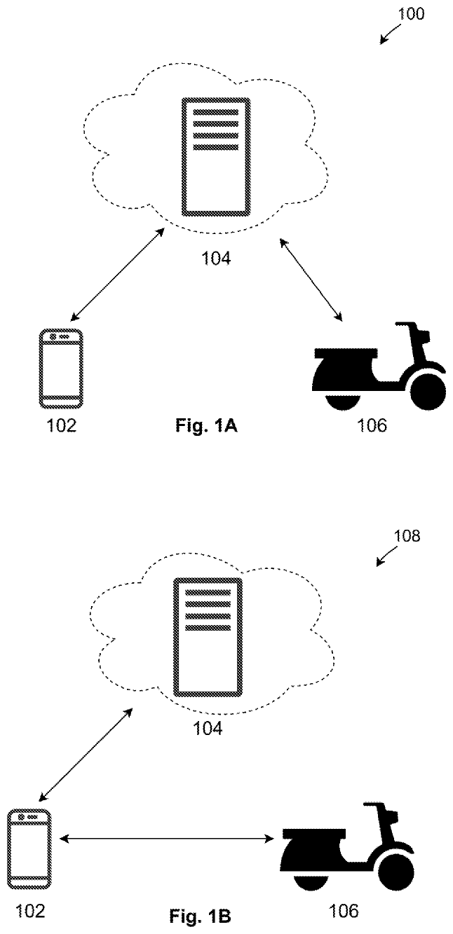

FIG. 1A shows the main elements of the system and their relationship to each other. Mobile device 102 communicates with lightweight vehicle 106 by way of cloud server 104.

FIG. 1B shows an alternative embodiment where mobile device 102 communicates directly with cloud server 104 and with lightweight vehicle 106 by, for example, a Bluetooth connection.

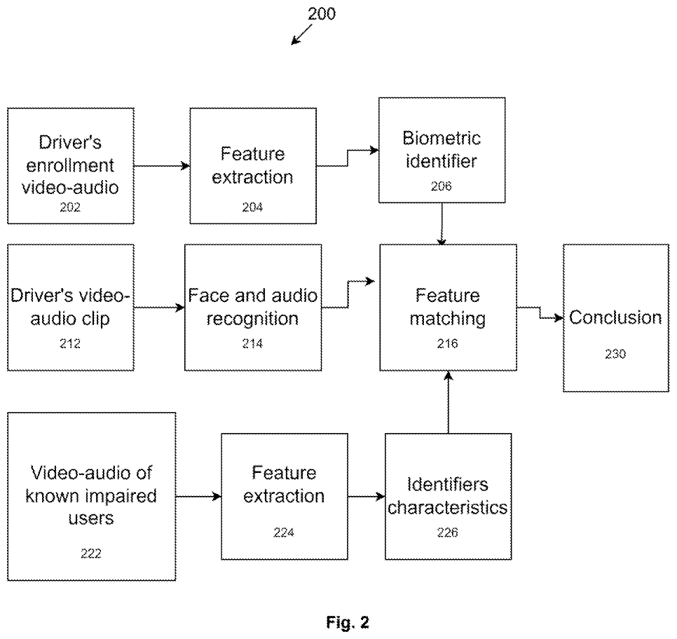

FIG. 2 shows an exemplary embodiment of machine learning model 200. In an embodiment, a prospective driver of lightweight vehicles in a shared fleet provides a sample of uniquely identifiable information upon enrollment. In an embodiment, the information comprises an image of the driver's face. In alternative embodiment, the information comprises an audio sample of the driver's voice. Other driver-specific information could also be used, including partial images of the driver's face or other identifiable characteristics of the driver.

At step 202, a driver's enrollment audio sample or image is collected. This audio sample or image is collected by way of a camera or microphone on a mobile device. Alternatively, the camera or microphone is external to the mobile device but linked to the device either wirelessly or with a wired connection or as an attachment.

At step 204, feature extraction is performed. A feature is an input variable used in making predictions. One feature is typically a class label that defines the class this instance belongs to. Feature extraction reduces the number of features in a dataset by creating new features from the existing ones. The original features may then be discarded.

At step 206, biometric identifiers of the driver's enrollment video or audio are collected as a result of feature extraction. These biometric features will be used later for feature matching with new test images of the driver.

At step 212, a driver's video image or audio sample is collected by the mobile device. This collection is done locally by the mobile device. In an embodiment, the collected image or audio sample is timestamped for verification that it reflects the driver's current state.

At step 214, the collected driver data undergoes feature extraction to identify face images, audio samples, or both. This collected data will be used at step 216 for feature matching.

At step 222, video images or audio samples are collected in a database of known impaired users.

At step 224, feature extraction is performed on the collected images or samples. The set of features extracted are saved as identifiers and characteristics at step 226.

At step 230, a conclusion is reached by using the collected driver image or audio sample as a test image or sample as input to the machine learning model. In an embodiment, conclusion 230 depends on comparing the features extracted from the driver in steps 212, 214, and 216 with both the biometric identifiers from step 206 and the identifiers and characteristics from step 226. In an alternative embodiment, biometric identifiers from step 206 are not used and the identifiers and characteristics from step 226 are used to reach conclusion 230.

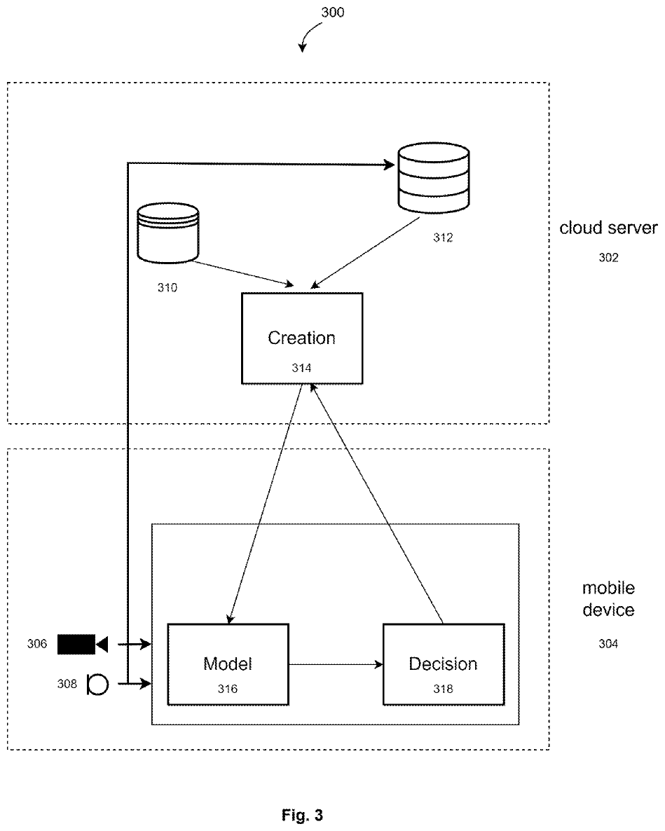

FIG. 3 shows an exemplary system configuration 300 of cloud backend server 302 and mobile device 304.

In an embodiment, a mobile device with camera 306 collects image data from a prospective driver. In an alternative embodiment, mobile device microphone 308 collects audio samples. In some embodiments, both camera 306 and microphone 308 are provided by the mobile device for collecting samples.

In an embodiment, database 310 comprises images of known impaired people. In an alternative embodiment, database 310 comprises audio samples of known impaired people. In a further embodiment, database 310 comprises both audio samples and images.

Database 312 comprises images or audio samples, or both, collected from mobile device 304. Database 312 and database 310 are used to create a machine learning model 314 by training the model to identify user-collected images or audio samples with examples of impairment. In an alternative embodiment, only database 312 is used to create the model.

Machine learning model 316 receives a test image from camera 306 or microphone 308, or both. Machine learning model 316 reaches decision 318 as described in connection with FIG. 2. The result of the decision is optionally sent to database 312 for optimizing the machine learning model.

In an embodiment, the mobile device is an Android or Apple smartphone. In some embodiments, the mobile device employs machine-learning hardware such as Google's Pixel Neural Core. Alternatively, the mobile device employs a GPU (Graphics Processing Unit) such as the Apple Bionic series, ARM Mali series, or Qualcomm Adreno. Alternatively, the mobile device uses a TPU (Tensor Processing Unit), AI hardware that implements all control and logic for machine learning algorithms. An example is Google's Coral Edge TPU, which includes a toolkit for local AI production including on-device AI applications that require low power consumption and offline workflows. Google Coral implementations enable machine learning frameworks such as TensorFlow Lite, YOLO, and R-CNN for object detection and object tracking.

1. A system for controlling access to a lightweight vehicle in a shared-vehicle fleet comprising:
a lightweight vehicle;
a mobile device communicatively coupled to an image-capture device;
a central server in communication with the mobile device;
a machine-learning database comprising images indicative of impairment;
a machine-learning model trained to compare test images of human faces to human faces of subjects known to be impaired;
a user face image collected from a potential driver of the lightweight vehicle by way of a mobile device;
an access-restriction mechanism for the lightweight vehicle, configured to be activated when the machine learning model determines that the user face image shows a probability of impairment exceeding a predetermined threshold.

2. The system of claim 1 wherein the machine learning model accesses a database of voice samples not collected from the potential driver.

3. The system of claim 1 wherein the machine learning model accesses a database of images of previously collected images that include the potential driver.

4. The system of claim 1 further comprising first and second machine-learning databases, wherein the first database comprises third-party face images and wherein the second database comprises images collected from user face images, and wherein the machine-learning model calculates probability of impairment separately for each machine-learning model.

5. The system of claim 1 further comprising first and second machine-learning databases, wherein the first database comprises third-party audio clips and wherein the second database comprises audio clips collected from users, and wherein the machine-learning model calculates probability of impairment separately for each machine-learning model.

6. The system of claim 1 further comprising first and second machine-learning databases, wherein the first database comprises third-party audiovisual clips and wherein the second database comprises audiovisual clips collected from users, and wherein the machine-learning model calculates probability of impairment separately for each machine-learning model.

7. A system for controlling access to a lightweight vehicle in a shared-vehicle fleet comprising:
a lightweight vehicle;
a mobile device communicatively coupled to an audio recording device;
a central server in communication with the mobile device;
a machine-learning database comprising audio samples indicative of impairment;
a machine-learning model trained to compare test audio samples to human voice samples of subjects known to be impaired;
a user voice sample collected from a potential driver of the lightweight vehicle by way of a mobile device;
an access-restriction mechanism for the lightweight vehicle, configured to be activated when the machine learning model determines that the user voice sample shows a probability of impairment exceeding a predetermined threshold.

8. The system of claim 7 wherein the machine learning model accesses a database of voice samples not collected from the potential driver.

9. The system of claim 7 wherein the machine learning model accesses a database of previously collected voice samples that include the potential driver.

10. The system of claim 7 further comprising first and second machine-learning databases, wherein the first database comprises third-party face images and wherein the second database comprises images collected from user face images, and wherein the machine-learning model calculates probability of impairment separately for each machine-learning model.

11. The system of claim 7 further comprising first and second machine-learning databases, wherein the first database comprises third-party audio clips and wherein the second database comprises audio clips collected from users, and wherein the machine-learning model calculates probability of impairment separately for each machine-learning model.

12. The system of claim 7 further comprising first and second machine-learning databases, wherein the first database comprises third-party audio clips and wherein the second database comprises audio clips collected from users, and wherein the machine-learning model calculates probability of impairment separately for each machine-learning model.

13. A method for controlling access to a lightweight vehicle within a shared-vehicle fleet comprising the steps of:
collecting audio or visual record from a potential driver of the vehicle by way of a mobile device;
calculating, with the machine learning model, a probability that the collected user record shows signs of impairment;
restricting access to the lightweight vehicle by way of a locking mechanism when the probability of impairment exceeds a predetermined threshold.

14. The method of claim 13 wherein the audio or visual record comprises an image of the potential driver's face.

15. The method of claim 13 wherein the audio or visual record comprises an audio sample of the potential driver's voice.

16. The method of claim 14 wherein the machine learning model accesses a database of images not collected from the potential driver.

17. The method of claim 14 wherein the machine learning model accesses a database of images of previously collected images that include the potential driver.

18. The method of claim 15 wherein the machine learning model accesses a database of voice samples not collected from the potential driver.

19. The method of claim 15 wherein the machine learning model accesses a database of previously collected voice samples that include the potential driver.

20. The method of claim 13 wherein the machine learning model does not access any previously collected audio or visual record from the potential driver.
